(19) United States
(12) Patent Application Publication
(10) Pub. No.: US 2026/0238286 A1
(43) Pub. Date: Aug. 13, 2026

(54) MACHINE LEARNING-BASED CONTROL INFORMATION CAPABILITY SIGNALING, REPORT CONFIGURATION, AND PAYLOAD DETERMINATION

(71) Applicant: QUALCOMM Incorporated, San Diego, CA (US)

(72) Inventors: Chenxi HAO, Beijing (CN); Jay Kumar SUNDARARAJAN, San Diego, CA (US); Taesang YOO, San Diego, CA (US); Eren BALEVI, Brooklyn, NY (US); Runxin WANG, San Diego, CA (US); Abdelrahman Mohamed IBRAHIM, San Diego, CA (US); Tingfang JI, San Diego, CA (US)

(21) Appl. No.: 19/157,677

(22) PCT Filed: Apr. 7, 2023
(86) PCT No.: PCT/CN2023/086806

§ 371 Date: Aug. 18, 2025

(51) Int. Cl. H04B 7/06; H04L 41/16

(52) U.S. Cl. CPC H04B 7/0626; H04B 7/0639; H04L 41/16

(57) ABSTRACT

Disclosed are systems, apparatuses, processes, and computer-readable media to wireless communication using machine learning (ML) models. A method of wireless communication includes determining capability information associated with at least one feature group, at least one identifier associated with one or more machine learning (ML) models, and at least one set of channel state information reference signal (CSI-RS) capabilities of the UE; transmitting the capability information to a network entity; and receiving a CSI report configuration comprising an identifier of the at least one identifier.

### FIELD

The present disclosure generally relates to artificial intelligence (AI)/machine learning (ML)-based systems for wireless communications. For example, aspects of the present disclosure relate to systems and techniques for providing AI/ML-based control information capability signaling, report configuration, and payload determination.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Artificial intelligence (AI) and ML based algorithms may be incorporated into the 5G. 6G and future standards to improve telecommunications and data services.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Artificial Intelligence/Machine Learning (AI/ML)-based models can be used for various purposes, such as for generating channel state information (CSI) feedback. For instance, a CSI ML encoder and/or a CSI ML decoder can replace a Precoding Matrix Indicator (PMI) used in wireless communications systems. The CSI ML encoder is analogous to a PMI searching algorithm in current systems, and the CSI ML decoder is analogous to the PMI codebook. For instance, the CSI ML decoder can be used to translate CSI reporting bits from the CSI ML encoder to a PMI codeword. However, there is no clear techniques for providing AI/ML-based control information capability signaling, report configuration, and/or payload determination (e.g., with respect to a payload of a message output by an AI/ML model of a UE).

Systems and techniques are described herein for providing machine learning-based control information capability signaling, report configuration, and payload determination. For instance, an ML-based encoder of a UE can be configured to pair with an ML-based decoder at a network entity (e.g., a base station, such as a gNB, or a portion of the base station, such as a central unit (CU), distributed unit (DU), radio unit (RU), Near-Real Time (Near-RT) radio access network (RAN) Intelligent Controller (RIC), or a Non-Real Time (Non-RT) RIC of the base station), which can also be referred to as a network entity. Information can be exchanged between the UE and the network entity to setup CSI reporting. In some cases, the UE may determine capability information associated with at least one feature group, at least one identifier associated with one or more ML models, and at least one set of CSI-RS capabilities of the UE. The UE may transmit the capability information to the network entity. In one aspect, the at least one identifier can identify a pair of ML-based models, such as an ML-based encoder for encoding the CSI and a corresponding ML-based decoder for decoding the CSI. In some aspects, the UE can receive explicit signaling from the network entity with an indication of a payload size, or can determine the payload size based on one or more parameters, of an output of the ML-based encoder of the UE (e.g., a compressed or latent representation of CSI feedback).

According to at least one example, a method of wireless communications at a user equipment (UE) includes: determining capability information associated with at least one feature group, at least one identifier associated with one or more machine learning (ML) models, and at least one set of channel state information reference signal (CSI-RS) capabilities of the UE; transmitting the capability information to a network entity; and receiving a CSI report configuration comprising an identifier of the at least one identifier.

In another illustrative example, an apparatus for wireless communications is provided that includes at least one memory and at least one processor (e.g., implemented in circuitry) coupled to the at least one memory and configured to: determine capability information associated with at least one feature group, at least one identifier associated with one or more ML models, and at least one set of CSI-RS capabilities of the apparatus; transmit the capability information to a network entity; and receive a CSI report configuration comprising an identifier of the at least one identifier.

In another illustrative example, a non-transitory computer-readable storage medium of a user equipment (UE) is provided that includes instructions stored thereon which, when executed by at least one processor, causes the at least one processor to: determine capability information associated with at least one feature group, at least one identifier associated with one or more ML models, and at least one set of CSI-RS capabilities of the UE; transmit the capability information to a network entity; and receive a CSI report configuration comprising an identifier of the at least one identifier.

In another illustrative example, an apparatus for wireless communications is provided that includes: means for determining capability information associated with at least one feature group, at least one identifier associated with one or more machine learning (ML) models, and at least one set of channel state information reference signal (CSI-RS) capabilities of the apparatus; transmitting the capability information to a network entity; and means for receiving a CSI report configuration comprising an identifier of the at least one identifier.

In another illustrative example, a method for wireless communications at a network entity includes: receiving capability information associated with at least one feature group, at least one identifier associated with one or more ML models, and at least one set of CSI-RS capabilities of a user equipment (UE); and transmitting a CSI report configuration to the UE comprising an identifier of the at least one identifier.

In another example, an apparatus for wireless communications is provided that includes at least one memory and at least one processor (e.g., implemented in circuitry) coupled to the at least one memory and configured to: receive capability information associated with at least one feature group, at least one identifier associated with one or more ML models, and at least one set of CSI-RS capabilities of a user equipment (UE); and transmit a CSI report configuration to the UE comprising an identifier of the at least one identifier.

In another illustrative example, a non-transitory computer-readable storage medium is provided that includes instructions stored thereon which, when executed by at least one processor, causes the at least one processor to: receive capability information associated with at least one feature group, at least one identifier associated with one or more ML models, and at least one set of CSI-RS capabilities of a user equipment (UE); and transmit a CSI report configuration to the UE comprising an identifier of the at least one identifier.

In another illustrative example, an apparatus for wireless communications is provided that includes: means for receiving capability information associated with at least one feature group, at least one identifier associated with one or more ML models, and at least one set of CSI-RS capabilities of a user equipment (UE); and means for transmitting a CSI report configuration to the UE comprising an identifier of the at least one identifier.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 illustrates an example architecture of a neural network that may be used in accordance with some aspects of the present disclosure;

FIG. 6 is a block diagram illustrating an ML engine, in accordance with aspects of the present disclosure;

FIG. 7 illustrates a block diagram showing an encoder encoding input to generate a latent message transmitted to a decoder at a third Generation Partnership Project (3GPP) gNodeB (gNB) that generate an output based on the latent message, in accordance with aspects of the present disclosure;

FIG. 8 illustrates an example decoder input and an example decoder output in accordance with various aspects of the disclosure;

FIG. 9 illustrates a configuration of a CSI-RS capabilities;

FIG. 10 is a conceptual diagram of illustrating d transmitting ML-based capabilities in accordance with various aspects of the disclosure;

FIG. 11 illustrates potential changes to implement ML-based CSI feedback or CSF by determining what capability a UE should report for ML-based CSI feedback;

FIG. 12 is a conceptual illustration of capability information reported from a UE to a network entity in accordance with some aspects of the disclosure;

FIG. 13 illustrates a conceptual diagram of reporting capability information in accordance with some aspects of the disclosure;

FIG. 14 is a flowchart of an example method 1400 for providing wireless communications at a UE in accordance with various aspects of the disclosure;

FIG. 15 is a flow diagram illustrating an example of a process or method 1500 for wireless communication from the standpoint of a network entity such as a base station in accordance with various aspects of the disclosure; and

FIG. 16 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Various techniques are provided in reference with wireless technologies (e.g., The third Generation Partnership Project (3GPP) 5G/New Radio (NR) Standard) to provide improvements to wireless communications. Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a third Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

Channel State Information (CSI) feedback can be used by network entity (e.g., a base station such as a third Generation Partnership Project (3GPP) gNodeB (NB)) in a wireless communications system to determine channel conditions so as to schedule downlink data transmissions. For example, a user equipment (UE) can receive a CSI-Reference Signal (CSI-RS) from a base station (e.g., a gNB) and perform channel estimation based on the CSI-RS. According to the current 3GPP Standard, the CSI report configuration includes a codebook, which is used as a Precoding Matrix Indicator (PMI) dictionary from which a UE can report the best PMI codewords based on channel and/or interference measurement from the received CSI-RS and/or one or more CSI-Interference Measurement (IM) resources. The UE can use a sequence of bits to report the PMI. For example, a CSI IM resource can include a set of specific resource elements reserved for Interference Measurement. In some cases, CSI IM resources are configurable by an RRC message transmitted by a base station (e.g., a gNB) and received by a UE.

With respect to X-node Channel State Feedback (CSF) or Channel State Information (CSI), there is a question of what to provide as feedback. CSI feedback can be used by network entity (e.g., a base station such as a 3rd Generation Partnership Project (3GPP) gNodeB (NB)) in a wireless communications system to determine channel conditions. For example, a user equipment (UE) can receive a CSI-Reference Signal (CSI-RS) from a network entity (e.g., a base station, such as a gNodeB (gNB)) and perform channel estimation based on the CSI-RS. According to the current 3GPP Standard, the CSI report configuration includes a codebook, which is used as a Precoding Matrix Indicator (PMI) dictionary from which a UE can report the best PMI codewords based on the received CSI-RS. The UE can use a sequence of bits to report the PMI.

In some cases, Artificial Intelligence/Machine Learning (AI/ML)-based CSI feedback may use a CSI ML encoder and/or a CSI ML decoder to replace the PMI. For instance, a UE that intends to convey CSI to a gNB can use the CSI ML encoder (e.g., an encoder neural network model) to derive a compressed representation (also referred to as a latent representation or latent message) of the CSI for transmission to the gNB. The gNB may use the CSI ML decoder (e.g., a decoder neural network model) to reconstruct the target CSI from the compressed representation. The CSI ML encoder is analogous to the PMI searching algorithm in current system. The CSI ML decoder is analogous to the PMI codebook and is used to translate the CSI reporting bits to a PMI codeword. However, there is no clear techniques for providing AI/ML-based control information capability signaling, report configuration, and/or payload determination (e.g., with respect to a payload of a message output by an AI/ML model of a UE).

Systems, apparatuses, processes (also referred to as methods), and computer-readable media (collectively referred to herein as “systems and techniques”) are described herein for providing machine learning-based control information capability signaling, report configuration, and payload determination. In some cases, an ML-based encoder at a UE is configured to pair with an ML-based decoder at a network entity (e.g., a base station, such as a gNB, or a portion of the base station, such as a central unit (CU), distributed unit (DU), radio unit (RU), Near-Real Time (Near-RT) radio access network (RAN) Intelligent Controller (RIC), or a Non-Real Time (Non-RT) RIC of the base station), which can also be referred to as a network entity. For example, information can be transmitted between the UE and the network entity to setup CSI reporting. In one illustrative aspect, the UE may determine capability information associated with at least one feature group, at least one identifier associated with one or more ML models, and at least one set of CSI-RS capabilities of the UE. The UE may transmit the capability information to the network entity. In one aspect, the at least one identifier can identify a pair of ML-based models, such as an ML-based encoder for encoding the CSI and a corresponding ML-based decoder for decoding the CSI. In some aspects, the UE can receive explicit signaling from the network entity with an indication of a payload size, or can determine the payload size based on one or more parameters, of an output of the ML-based encoder of the UE (e.g., a compressed or latent representation of CSI feedback).

Additional aspects of the present disclosure are described in more detail below with respect to the figures. Illustrative aspects are also provided in Appendix A provided herewith.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

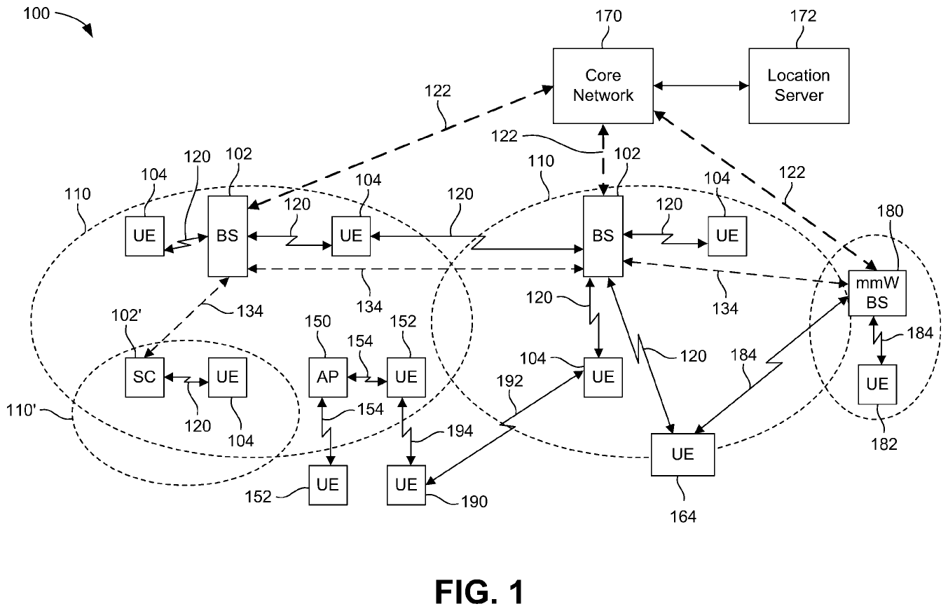

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHZ and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

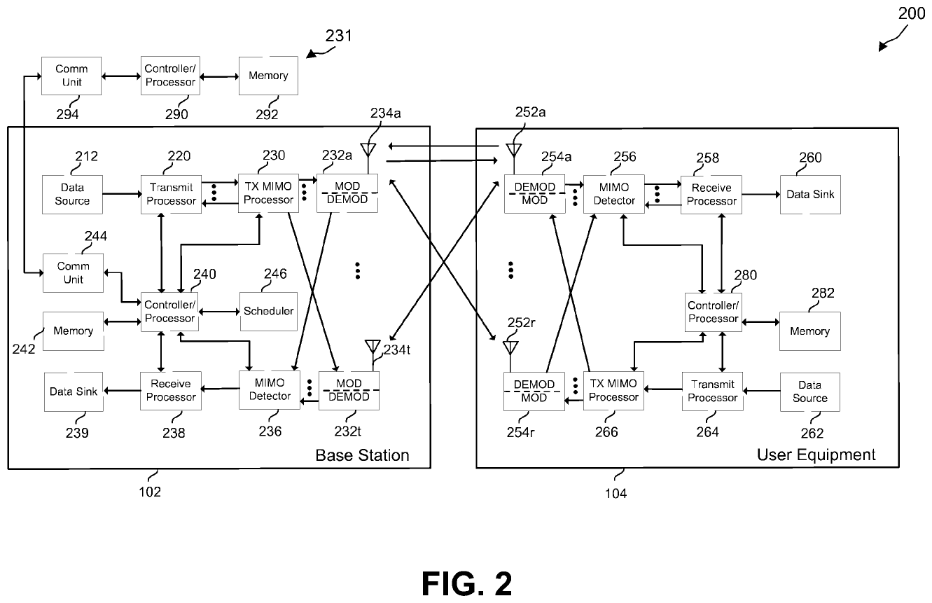

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

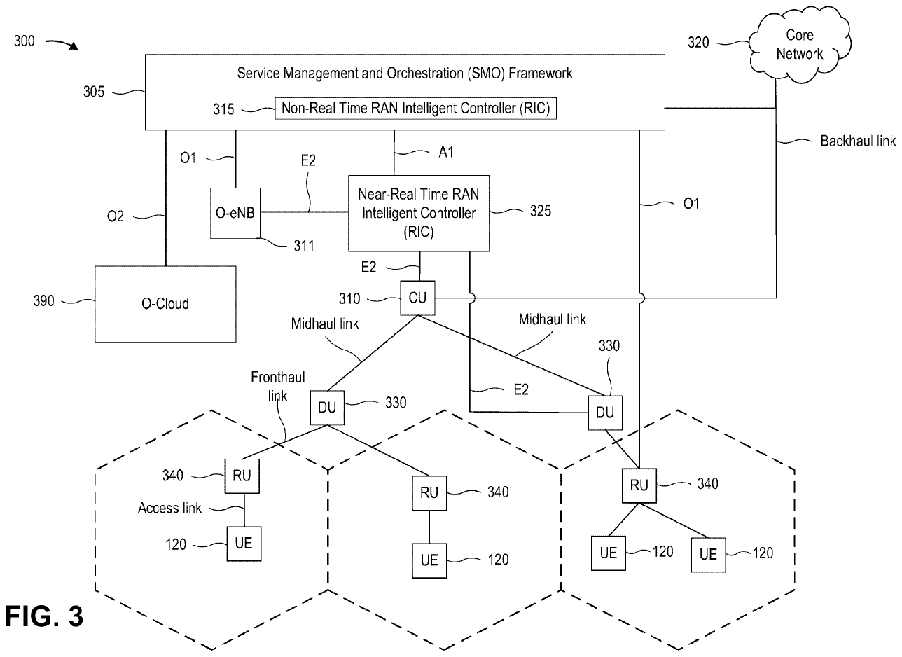

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the El interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an Ol interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

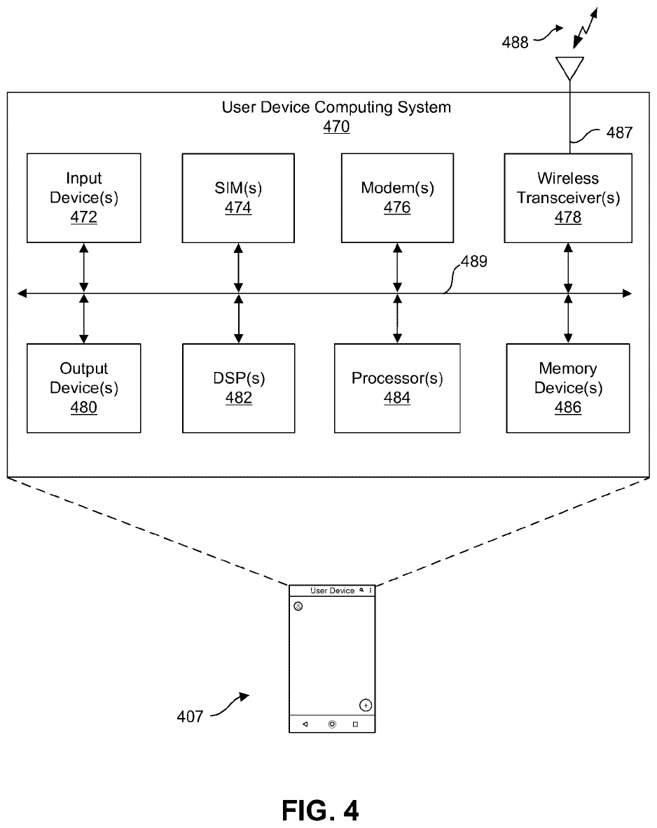

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network entitys (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

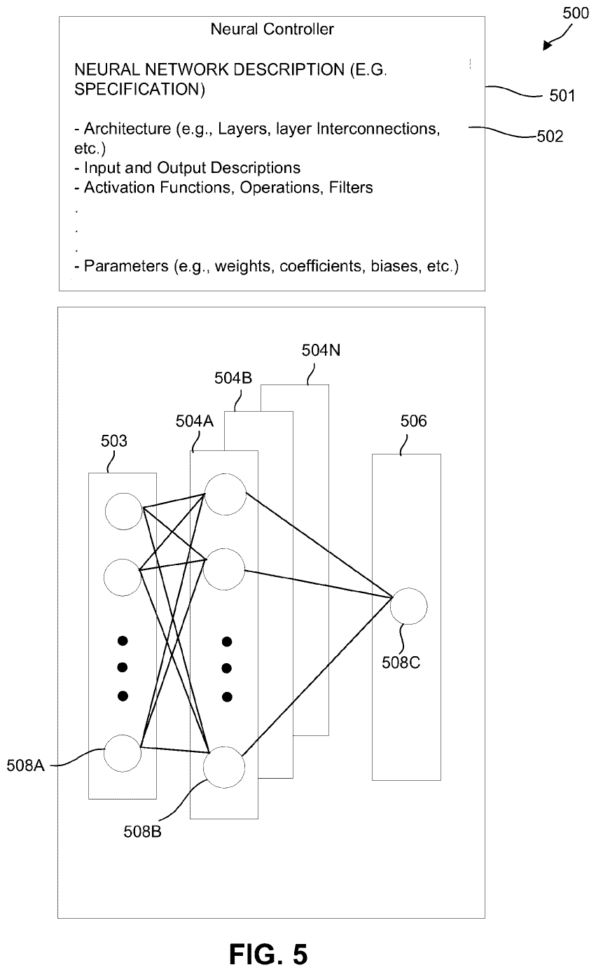

FIG. 5 illustrates an example architecture of a neural network 500 that may be used in accordance with some aspects of the present disclosure. The example architecture of the neural network 500 may be defined by an example neural network description 502 in neural controller 501. The neural network 500 is an example of a machine learning model that can be deployed and implemented at the base station 102, the central unit (CU) 310, the distributed unit (DU) 330, the radio unit (RU) 340, and/or the UE 104. The neural network 500 can be a feedforward neural network or any other known or to-be-developed neural network or machine learning model.

The neural network description 502 can include a full specification of the neural network 500, including the neural architecture shown in FIG. 5. For example, the neural network description 502 can include a description or specification of architecture of the neural network 500 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 500 can reflect the neural architecture defined in the neural network description 502. The neural network 500 can include any suitable neural or deep learning type of network. In some cases, the neural network 500 can include a feed-forward neural network. In other cases, the neural network 500 can include a recurrent neural network, which can have loops that allow information to be carried across nodes while reading in input.

The neural network 500 can include any other suitable neural network or machine learning model. One example includes a convolutional neural network (CNN), which includes an input layer and an output layer, with multiple hidden layers between the input and out layers. The hidden layers of a CNN include a series of hidden layers as described below, such as convolutional, nonlinear, pooling (for downsampling), and fully connected layers. In other examples, the neural network 500 can represent any other neural or deep learning network, such as an autoencoder, a deep belief nets (DBNs), a recurrent neural network (RNN), a generative-adversarial network (GAN), etc.

In the non-limiting example of FIG. 5, the neural network 500 includes an input layer 503, which can receive one or more sets of input data. The input data can be any type of data (e.g., image data, video data, network parameter data, user data, etc.). The neural network 500 can include hidden layers 504A through 504N (collectively “504” hereinafter). The hidden layers 504 can include n number of hidden layers, where n is an integer greater than or equal to one. The n number of hidden layers can include as many layers as needed for a desired processing outcome and/or rendering intent. In one illustrative example, any one of the hidden layers 504 can include data representing one or more of the data provided at the input layer 503. The neural network 500 further includes an output layer 506 that provides an output resulting from the processing performed by hidden layers 504. The output layer 506 can provide output data based on the input data.

In the example of FIG. 5, the neural network 500 is a multi-layer neural network of interconnected nodes. Each node can represent a piece of information. Information associated with the nodes is shared among the different layers and each layer retains information as information is processed. Information can be exchanged between the nodes through node-to-node interconnections between the various layers. The nodes of the input layer 503 can activate a set of nodes in the first hidden layer 504A. For example, as shown, each input node of the input layer 503 is connected to each node of the first hidden layer 504A. The nodes of the hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of the output layer 506, at which point an output can be provided. In some cases, while nodes (e.g., nodes 508A, 508B, 508C) in the neural network 500 are shown as having multiple output lines, a node can have a single output and all lines shown as being output from a node can represent the same output value.

In some cases, each node or interconnection between nodes can have a weight that is a set of parameters derived from training the neural network 500. For example, an interconnection between nodes can represent a piece of information learned about the interconnected nodes. The interconnection can have a numeric weight that can be tuned (e.g., based on a training data set), allowing the neural network 500 to be adaptive to inputs and able to learn as more data is processed.

The neural network 500 can be pre-trained to process the features from the data in the input layer 503 using different hidden layers 504 in order to provide the output through the output layer 506. For example, in some cases, the neural network 500 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned (e.g., meet a configurable threshold determined based on experiments and/or empirical studies).

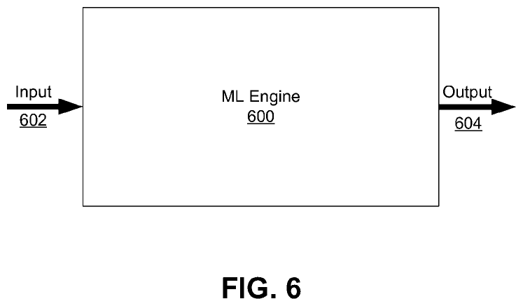

Increasingly ML (e.g., AI) algorithms (e.g., models) are being incorporated into a variety of technologies including wireless telecommunications standards. FIG. 6 is a block diagram illustrating an ML engine 600, in accordance with aspects of the present disclosure. As an example, one or more devices in a wireless system may include the ML engine 600. In some cases, ML engine 600 may be similar to neural network 500. In this example, ML engine 600 includes three parts, input 602 to the ML engine 600, the ML engine, and the output 604 from the ML engine 600. The input 602 to the ML engine 600 may be data from which the ML engine 600 may use to make predictions or otherwise operate on. As an example, an ML engine 600 configured to select an RF beam may take, as input 602, data regarding current RF conditions, location information, network load, etc. As another example, data related to packets sent to a UE, along with historical packet data may be input 602 to an ML engine 600 configured to predict a discontinuous reception (DRX) schedule for the UE. In some cases, the output 604 may be predictions or other information generated by the ML engine 600 and the output 604 may be used to configure a wireless device, adjust settings, parameters, modes of operations, etc. Continuing the previous examples, the ML engine 600 configured to select an RF beam may output 604 a RF beam or set of RF beams that may be used. Similarly, the ML engine 600 configured to predict a DRX schedule for the UE may output a DRX schedule for the UE.

In another example, the ML engine 600 may be an encoder used to compress channel state information (e.g., channel state information (CSI) or channel state feedback (CSF)) determined by a UE in order to generate a representation (e.g., a latent representation) of the control information. In another example, the ML engine 600 may be an encoder used by a network entity (e.g., a base station) to decode a representation (e.g., a latent representation) of the control information (e.g., CSI) generated by a UE.

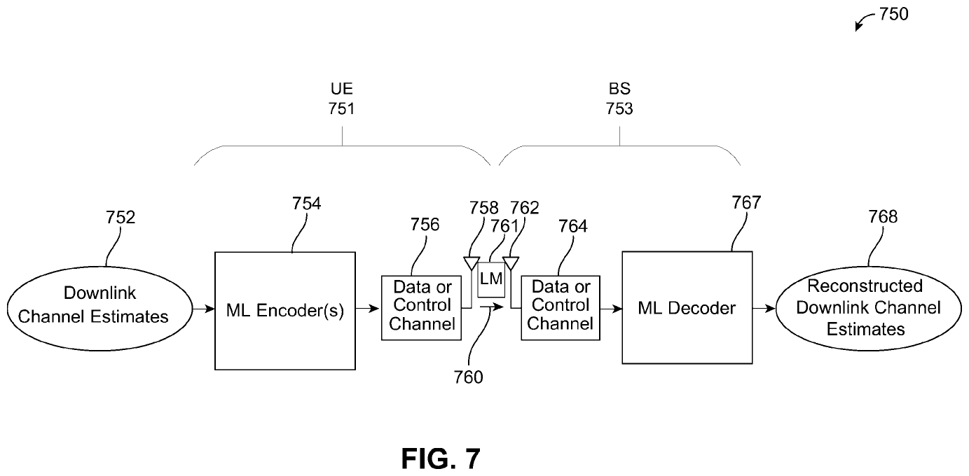

FIG. 7 is a diagram illustrating an example of a network 750 including a UE 751 and a base station 753 (e.g., a gNB or a portion of a gNB, such as a CU, DU, RU, etc. of a gNB having a disaggregated architecture). As shown in FIG. 7, downlink channel estimates 752 (e.g., CSI or CSF) are provided to an encoder 754 of the UE 751. The CSI encoder 754 encodes the CSI and the UE 751 transmits the encoded CSI (e.g., a latent representation of the CSI as a latent message 761, such as a feature vector representing the CSI) using antenna 758 via a data or control channel 756 over a wireless or air interface 760 to a receiving antenna 762 of the base station 753. In some cases, the UE 751 can transmit a latent message representing the CSI 761. As noted above, the CSI encoder 754 can replace the PMI codebook which was used to translate the CSI reporting bits to a PMI codeword.

The encoded CSI or latent message 761 is provided via a data or control channel 764 to a CSI decoder 767 of the base station 753 that can decode the encoded CSI to generate a reconstructed downlink channel estimate 768 (or reconstructed CSI). In some cases, the base station 753 can then determine a precoding matrix, a modulation and coding scheme (MCS), and/or a rank associated with one or more antennas of the base station. Based on the precoding matrix, the MCS, and/or the rank, the base station 753 can determine a configuration of control resources (e.g., via a physical downlink control channel (PDCCH)) or data resources (e.g., via a physical downlink shared channel (PDSCH)).

The decoder output could be a number of different data structures. For example, the decoder output could be a downlink channel matrix (H), a transmit covariance matrix, downlink precoders (V), an interference covariance matrix (Rnn), or a raw vs. whitened downlink channel. In some examples, when the encoder input is (H) (a channel matrix), the decoder output could be H (a channel matrix) or V (an eigen vector) or SV (eigen values times V). When the encoder input is an eigen vector V, the decoder output could be also an eigen vector V. When the encoder input is the inference covariance matrix Rnn, the output could also be an interference covariance matrix Rnn. The H or V values can correspond to a raw channel or to a channel pre-whitened by the UE 751 based on its demodulation filter.

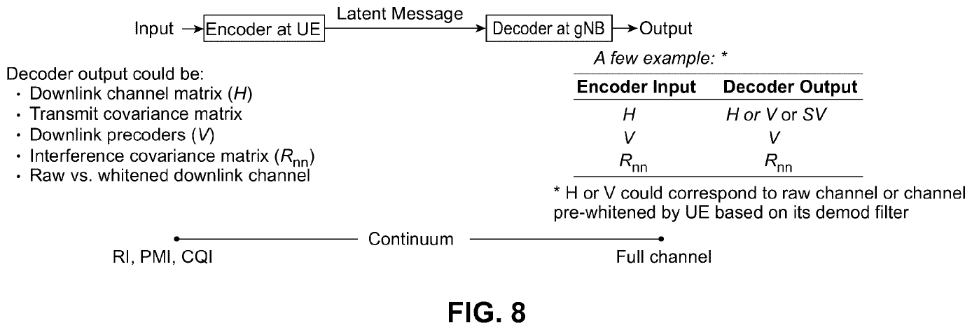

In some cases, Artificial Intelligence/Machine Learning (AI/ML)-based CSI feedback may use a CSI ML encoder and/or a CSI ML decoder to replace the PMI. The ML encoder is analogous to the PMI searching algorithm in current system. The ML decoder is analogous to the PMI codebook and is used to translate the CSI reporting bits to a PMI codeword. An example of such an ML-based CSI feedback system is shown in FIG. 8 below, along with inputs to the ML encoder and outputs to the ML decoder.

FIG. 8 illustrates an example decoder input and an example decoder output in accordance with various aspects of the disclosure. In some cases, the decoder output could be one or more of a downlink channel matrix (H), a transmit covariance matrix, downlink precoders (V), interference covariance matrix (Rnn), raw vs. whitened downlink channel, any combination thereof, and/or other information.

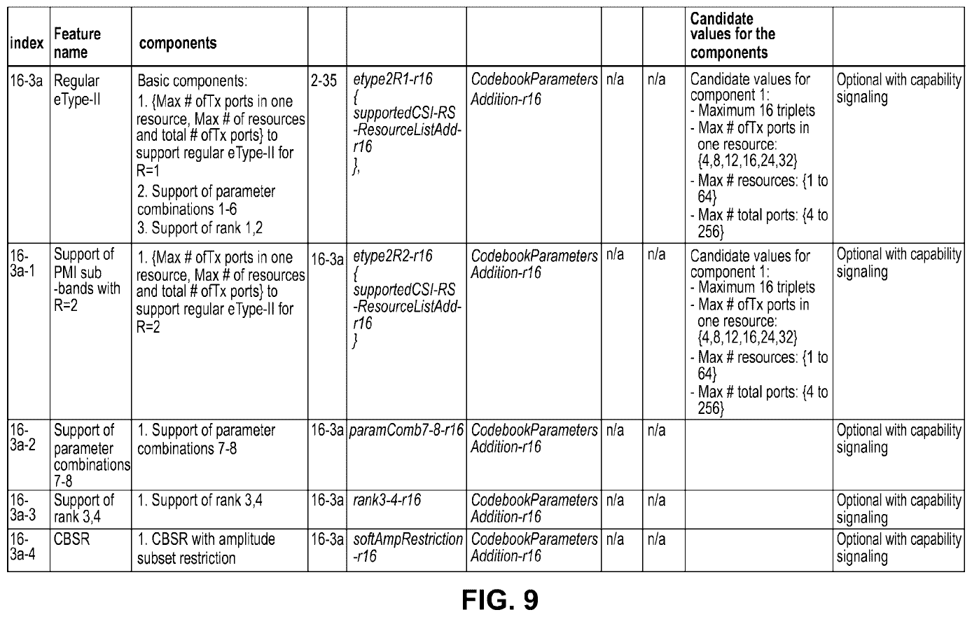

FIG. 9 illustrates a configuration of CSI-RS capabilities that can be transmitted by a UE to a network entity (e.g., a base station, such as a gNB, or a portion thereof), such as for capability reporting for a PMI codebook. With respect to capability reporting for a PMI codebook, a UE can report CSI-RS capabilities, in terms of {maximum number (#) of ports per resource, maximum number of resources, maximum number of total ports} for basic components, to represent the complexity for the UE to support the basic feature. Other features indexed by 16-3a-x in FIG. 9 are optional features for eT2 codebook with additional signaling (a.k.a., sub-level features). The UE may further report CSI-RS capabilities to support the additional features, e.g., 16-3a-1 in FIG. 9 below. The UE may report support or no support for additional features, e.g., as illustrated by reference numerals 16-3a-2, 16-3a-3, 16-3a-4 in FIG. 9.

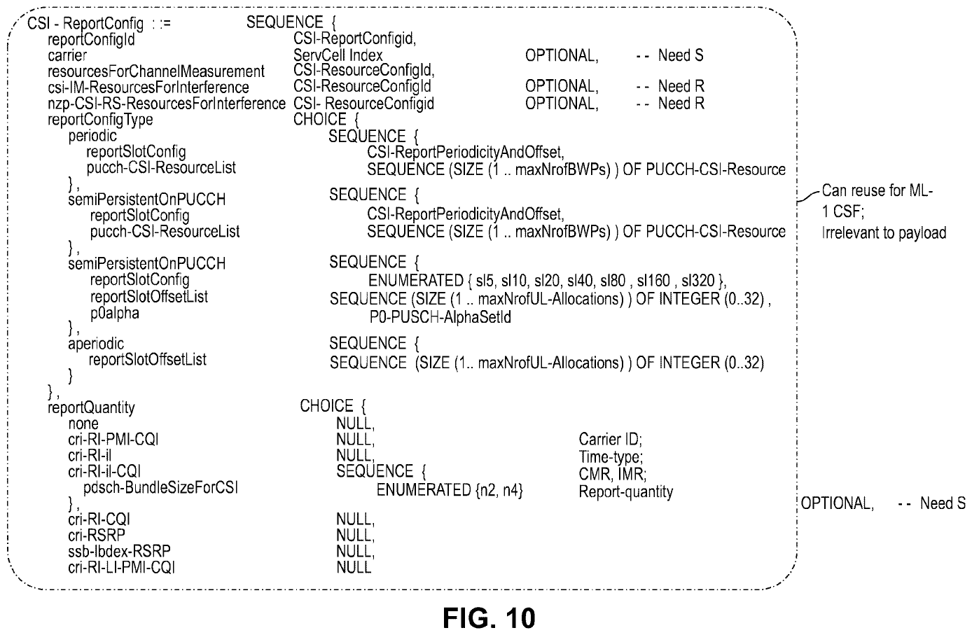

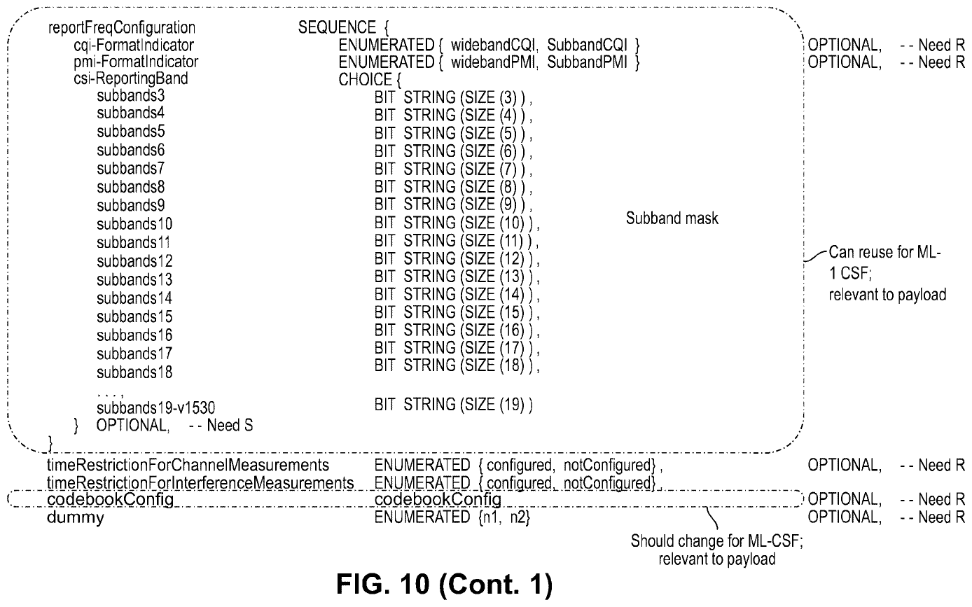

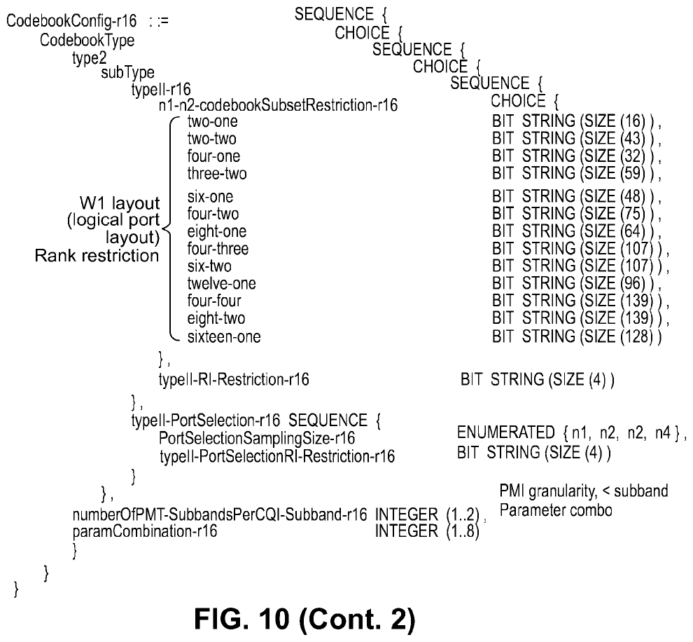

FIG. 10 is a conceptual diagram illustrating RRC signaling including a CSI-ReportConfig message. In some cases, a network entity (e.g., a base station, such as a gNB) can configure CSI-ReportConfig including carrier ID, time-type of the report, CMR, IMR, report-quantity, frequency configuration (subbands) and codebook configurations, such as based on the syntax illustrated in FIG. 10. In some cases, the ML-based CSI feedback or CSF may be configured to be different from conventional CSI feedback.

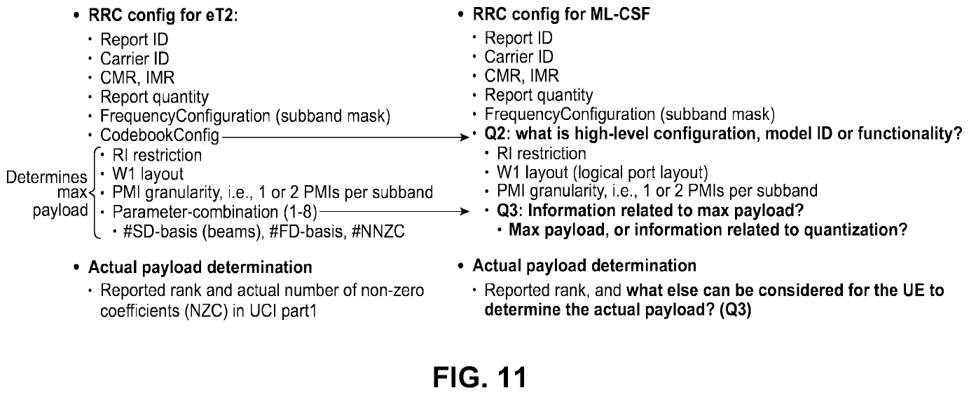

FIG. 11 illustrates potential changes to implement ML-based CSI feedback or CSF by determining what capability a UE should report for ML-based CSI feedback/CSF. In some aspects, UE reports capability related to the ML-based two-sided CSI feedback (e.g., as shown in FIG. 7). Analogous to legacy codebook-based CSI reporting, the UE may need to report the capability for various functionalities supported by the ML model. In some aspects, the UE and the base station (e.g., gNB) may develop various pairs of ML models, where each different model may support different functionalities with a certain capability. In some aspects, the PMI or the codebook can be omitted and various information can be encoded by an ML model at the UE into a latent message output by the ML model (e.g., a vector representation of CSI feedback or CSF output by an ML-based encoder at the UE, such as the ML encoder 754 of FIG. 7). For example, the codebook configuration can include rank indictor restrictions, W1 layout, PMI granularity, and identification or parameter combinations. In one illustrative example, parameter combinations can include a combination of the number of spatial domain (SD) bases or beams, the number of frequency domain (FD) bases, and the number of non-zero coefficients.

In some cases, the latent message may include a feature representation of the CSI (e.g., the latent message 761 of FIG. 7) described above and reduce overhead associated with reporting CSI. The latent message also has a particular maximum payload, and the UE may perform different techniques according to aspects described herein for determining a maximum size of a payload for the latent message.

As noted previously, systems and techniques are described herein for performing ML-based control information capability signaling, report configuration, and payload determination. Various aspects are described below. In some aspects, the systems and techniques can provide feature groups and a pairing identifier (ID) for ML-based CSI feedback or CSF (referred to as ML-CSF). For instance, the pairing ID is a naming process in the model development phase. In one example, a paired logical UE-side model and a logical network (NW)-side model (e.g., on a base station, such as a gNB) can be developed for a specific scenario or purpose (e.g., for CSI feedback or CSF, as described above with respect to FIG. 7). For example, the pairing identifiers can be associated with one or more criteria or conditions such as a zone, region, scenario, site, a cell, or other criteria.

The criteria/condition for determining a pairing ID can be based on one or more vendor offline agreements. A paired model may achieve a basic feature, a medium feature, an advanced feature, or any combination thereof. Feature groups (or sub-features) of a PMI report can be provided, such as eT2 para-combo, rank, etc. For instance, for ML-CSF, feature groups can be considered as one or combination of rank, number of SBs, payload (similar to legacy CSI capabilities), number of PMIs per subband, precoding restrictions, etc. In one example, basic features can include a rank 1-2, up to 13 SBs, and low/medium payloads. In another example, medium features can include a rank 3-4, up to 13 SBs, and low/medium payloads. In another example, advanced features can include a rank 3-4, 13 to 19 SBs, and high payloads. In some cases, there can be a precoding matrix restriction (e.g., a UE is not allowed to report the precoder along some spatial directions) to mitigate intercell interference. As an example, a gNB may ask a UE to report the precoder along some other directions to prevent interference to the neighboring cell.

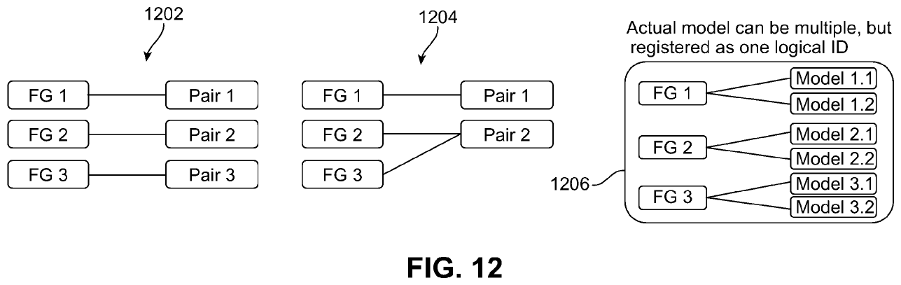

FIG. 12 is a conceptual illustration of capability information reported from a UE to a network entity according to aspects described herein. In some aspects, the capability information can be include pairs of information. For example, pair information 1202 includes feature groups (FGs) that are one-to-one mapped with a respective pair identifier (e.g., FG1 is mapped to Pair ID 1, FG2 is mapped to Pair ID 2, and FG3 is mapped to Pair ID 3). In such an example, one or more ML models registered with Pair ID1 is/are developed to achieve FG1, one or more ML ML models registered with Pair ID2 is/are developed to achieve FG2, an one or more ML models registered with Pair ID3 is/are developed to achieve FG3. In other aspects, pair information 1204 can include pair information that corresponds to different feature groups. For example, pair 2 in pair information 1204 corresponds to feature groups FG2 and FG3. In such an example, one or more ML models registered with Pair ID2 is/are developed to achieve FG2 and FG3. In some cases, the feature groups may be logical identifiers that are associated with different models. For example, pair information 1206 includes feature groups that are mapped to a plurality of other models. In some aspects, the network entity (e.g., a gNB) may not be aware of specific models implemented at the UE and the feature groups in the pair information 1206 enable the UE to select a model based on the logical pair identifier. In some aspects, the UE may encode information (e.g., CSI) to generate a latent message (e.g., a feature representation of the CSI) based on the specific ML-based model (e.g., an ML-based encoder) the UE selects, which can be decoded by an ML-based decoder on the network entity. For example, for a feature group comprising low and medium payload configuration, a UE may use a single ML model to achieve the low and medium payload feedback, while another UE may design two ML models to achieve low and medium payload feedback respectively. However, these two ML models are registered with the same logical pair ID.

In some aspects, the systems and techniques can provide capability signaling and Radio Resource Control (RRC) configuration. For example, a UE can report capabilities in terms of the mapping between CSI-RS capabilities, feature groups, and pairing IDs. CSI-RS capabilities can provide an assessment of the complexity of UE processing CSI measurement and computation, such as with respect to CSI-RS resources, number of ports/resource (# ports/res), number of total ports (# total ports), etc. For instance, in any slot, the UE is not expected to have more active CSI-RS ports or active CSI-RS resources in active bandwidth parts (BWPs) than reported as capability. Non-zero-power (NZP) CSI-RS resource is active in a duration of time defined as follows. For aperiodic CSI-RS, starting from the end of the PDCCH containing the request and ending at the end of the scheduled physical uplink shared channel (PUSCH) containing the report associated with this aperiodic CSI-RS. When the PDCCH candidates are associated with a search space set configured with searchSpaceLinking, for the purpose of determining the NZP CSI-RS resource active duration, the PDCCH candidate that ends later in time among the two linked PDCCH candidates is used. For semi-persistent CSI-RS, starting from the end of when the activation command is applied, and ending at the end of when the deactivation command is applied. For periodic CSI-RS, starting when the periodic CSI-RS is configured by higher layer signalling, and ending when the periodic CSI-RS configuration is released. If a CSI-RS resource is referred N times by one or more CSI Reporting Settings, the CSI-RS resource and the CSI-RS ports within the CSI-RS resource are counted N times. For a CSI-RS Resource Set for channel measurement configured with two Resource Groups and N Resource Pairs, if a CSI-RS resource is referred X times by one of the M CSI-RS resources, where M is defined in clause 5.2.1.4.2, and/or one or two Resource Pairs, the CSI-RS resource and the CSI-RS ports within the CSI-RS resource are counted X times.

In one illustrative example, in any slot, a UE is not expected to have more than eight (8) active resources for Type I CSI, and Is not expected to have more than one (1) active resource for Type II CSI. In a similar illustrative example for ML-CSF, a UE is not expected to have more than K active resources for a pairing ID or feature group if the UE reports K resource for that pairing ID or feature group. CSI-RS capabilities may be defined not only for resources, but also for number of ports/resource (# ports/res) and number of total ports (# total ports). In one illustrative example, if the UE reports {P, K, Ptot} for the CSI-RS triplet, the UE is not expected to have more than K resource or more than Ptot total ports if the number of ports per resource is not greater than P.

In a first illustrative option (referred to as Option 1) according to aspects described herein, for each pairing ID, a UE can report the supported feature groups, and the corresponding CSI-RS capability. For instance, the UE may report CSI-RS capability for basic feature, and may report {supported, not supported} for other more advanced features. In some cases, the UE may additionally or alternatively report CSI-RS capability for other more advanced features. In some cases, for each feature, the UE may report multiple CSI-RS triplets wherein a CSI-RS triplet is {maximum number of ports/resource, maximum number of resources, maximum number of total ports}. In some cases, the supported features (including the basic feature) can be different for different pairing IDs.

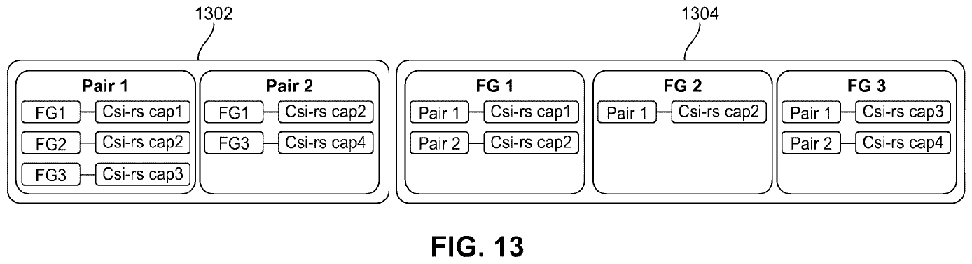

In a second illustrative example (referred to as Option 2), for each feature group, the UE can report the supported pairing ID and its CSI-RS capability. In some cases, at least one pairing ID should be supported for the basic feature group. In some aspects, CSI-RS capabilities={maximum number of ports/resource, maximum number of resources, maximum number of total ports}. In some cases, the pairing ID is a part of the feature group. For example, a feature group is defined as {supported rank, supported payload range, Pairing ID} or {supported rank, supported payload range, PMI granularity, Pairing ID} or {supported rank, supported payload range, supported bandwidth or number of subbands, Pairing ID}. For Option 1 and/or Option 2, reporting the feature groups can be reporting a feature group index from a pool; reporting the CSI-RS capability can be reporting a CSI-RS capability ID from a pool. An illustrative example is shown in FIG. 12 and FIG. 13. In some cases, Option 1 is considered as model-ID based life cycle management (LCM) where feature groups and CSI-RS capability are reported per pairing ID, and Option 2 is considered as functionality-based LCM where pairing ID is part of the functionality/feature group definition.

FIG. 13 illustrates a conceptual diagram of reporting capability information according to Option 1 and Option 2. In some cases, capability information 1302 is generated by the UE based on pair identifiers, features groups, and CSI-RS capabilities supported by the UE according to Option 1. For example, pair identifier 1 in the capability information 1302 indicates that the ML model(s) implemented by the UE registered with pair ID 1 supports feature group FG1 with CSI-RS capabilities CSR-RSI cap1, feature group FG2 with CSI-RS capabilities CSR-RSI cap2, and feature group FG3 with CSI-RS capabilities CSR-RSI cap3. Pair identifier 2 in the capability information 1302 indicates that ML model(s) implemented by the UE registered with pair identifier 2 supports FG1 with CSI-RS capabilities csi-rs cap2 and supports FG3 with CSI-RS capabilities csi-rs cap4.

In another aspect, the capability information 1304 may be generated by the UE based on feature groups according to Option 2. The capability information 1304 can group pair identifiers with different CSI-RS capabilities and map the groups to different feature groups. For example, the capability information 1304 indicates feature group FG1 is supported with pair identifier 1 with CSI-RS capability 1, and is supported with pair identifier 2 with CSI-RS capability 2. The capability information 1302 and 1304 can be reported identifying a feature group index from a pool of feature groups. The reporting the CSI-RS capability can be reporting a CSI-RS capability ID from a pool of CSI-RS capabilities that are predetermined. In another aspect, UE may report capability information as a combination of pairing ID and feature group. The combination of pairing ID and feature group is considered as a functionality. The UE may report the CSI-RS capabilities for the functionality.

In some aspects, the capability signaling is per band, per band-combination, and per-cell (e.g., site/cell-specific) capability. For example, the cell-specific can be achieved by naming the pairing ID associated with a cell ID. In some aspects, the pairing ID is associated with NW vendors. For instance, the pairing ID for a first NW vendor is different from the pairing ID for a second NW vendor. This is because some UE(s) may implement different ML models for different NW vendors so that they cannot share the same ID when performing inference of the ML models with the first NW vendor and the second NW vendor.

As an example of a CSI-Report setting, one or more pairing IDs can be configured, in some cases with following additional information (if needed): rank-restriction, subband mask, payload configuration, antenna port layout configuration, precoding matrix restriction, any combination thereof, and/or other information. In some cases, the configuration should honor the capability signaling.

In some aspects, the systems and techniques can make a payload determination (with respect to NW configuration). In some cases, an eT2 payload can be determined based on: number of subbands (# SB), antenna layout, number of antenna ports (# ports), number of FD basis, rank, number of non-zero coefficients, rank, and/or other information. In one illustrative example, W=W₁ W₂ [symbol] , where W₁ is the spatial domain (SD) basis (e.g., the number of SD basis=number of columns in W₁), W₂ is the coefficient matrix, and W_{f} is the frequency domain (FD) basis (e.g., the number of FD basis=number of columns in W_{f}). The maximum rank can be configured by rank restriction, and actual rank can be reported by the UE in Uplink Control Information (UCI) part 1. The max NNZC (in W2 matrix) can be configured by parameter-combination index, and actual NNZC can be reported by UE in UCI part 1. According to the aspects described herein, ML-CSF payload may be determined based on: number of sub-bands (SBs), antenna layout, number of ports, latent message payload, rank, any combination thereof, and/or other information. Configuration and reporting of rank can be reused. Configuration of number of SBs, antenna layout, and number of ports can be reused, but it may need to be decided how final payload scales with them. Configuration of latent message payload and its reporting may need new signaling design.

Other aspects of the disclosure include identification of payload information. In some cases, the payload information can be explicit and include a plurality of parameters for explicitly setting the size of the latent message.

In one illustrative example of payload determination with respect to a network entity configuration (referred to as Example 1), a network entity (e.g., a base station, such as a gNB, or a portion thereof) can explicitly configure a maximum payload for the latent message. In some cases (referred to as case 1.1), the max payload is per subband or subband range, per port or port range, and/or per rank or per rank-group. In some examples, the number of bits N_1 is 32 for number of subbands <=6, the number of bits N_2 is 64 for the number of subbands >6 but <=12, the number of bits N_3=96 for the number of subbands >12. With respect to rank the number of bits for rank N_1,2 is 64 for each layer of rank 1/2, N_3,4 is 32 is for each layer of rank 3/4. In some cases (referred to as case 1.2), the max payload is per basic subband, which is predetermined by the network entity, and the max payload for other # SB scales with this configured number. In some examples, N=┌N_0×α×N_SB/N_(SB, basic)┐, where N_0 is the max payload per N_(SB, basic) SBs. In some cases (referred to as case 1.3), the max payload is per basic # port, and the max payload for other # port scales with this configured number. In some examples, N=┌N_0×β×N_port/N_(port, basic)┐, where N_0 is the max payload per N_(ports, basic) ports. In some aspects, the max payload of case 1.1 and scaling factor of cases 1.2 and 1.3 (alpha and beta respectively), are pre-defined in standard or determined per model ID or functionality in offline model development. According to cases 1.1, 1.2, and 1.3, among other cases, the payload determination can scale with the number of subbands or the subband range, the number of ports or the port range, or the rank or rank-group

In another illustrative example of payload determination with respect to NW configuration (referred to as Example 2) may be implicit. For example, a latent message (e.g., per layer) payload can be parameterized by total dimensions of a CSI feature representation of the CSI report output by one or more ML encoders of the UE, a codeword length for quantization of a subset of values of the CSI feature representation, or a number of bits used for quantization of the subset of values of the CSI feature representation (e.g., {dimension d_z, quantization bits Q, codeword length cw_len}, where dimension dz is a dimension of the latent message, Q is a number of bits used for quantization, and codeword length cw_len is a codeword length for quantization). For example, the final payload can be determined by N=Q×d_z/(CW_len) (or N=Q×d_z/(CW_len)×RI if {d_z, Q, CW_len} is configured per layer, and RI is the rank reported by the UE). In some cases, at least one of {d_z, Q, cw_len} is developed offline per model ID or per functionality. In some examples, at least one of {d_z, Q, cw_len} is configured by the NW (e.g., by a base station, such as a gNB). In some cases, the dictionary is non-standardized and it is developed per model ID or per functionality.

For example, dimension d_z may be parameterized with 64 dimensions (d_z=64) {z₁, z₂, z₃, z₄, z₅ . . . z₆₄} with a codeword length cw_len of 4. In this case, vectors z₁, z₂, z₃, z₄ are quantized into a single vector represented by Q bits. According to aspects of the disclosure, dimension d_z, quantization bits Q, or codeword length cw_len can scale with the number of subbands or the subband range, the number of ports or the port range, or the rank or rank-group In some aspects, the systems and techniques provide solutions for UE-based payload determination. For instance, the principle of actual payload determination in Release 15, 16, and 17 (R15/16/17) includes, during the CSI calculation, a UE is able to observe there are less non-zero-coefficients in W2 matrix, so that UE does not need to quantize and report those near-zeros. The observation is a by-product of CSI calculation, and does not impose any complexity burden.

In some aspects, the systems and techniques described herein can provide alternatives that can compress the latent message with number of non-zero configuration (NNZC) reporting. In one aspect, the UE can report the actual non-zero entries in latent message. In another aspect, the UE can explicitly report NNZC and their location (e.g., which may result in even larger overhead than reporting them all). In another illustrative aspect, the UE can identify a pattern of non-zero entries that are pre-defined, and a UE can report an index corresponding to the non-zero entries (if UE observes non-zero entries on a predefined pattern and other location are nearly zeros). In another illustrative example, a UE can report number of non-zero entries only, with the trailing last d_z-K_NZ entries are zeros, where K NZ is the number of non-zeros.

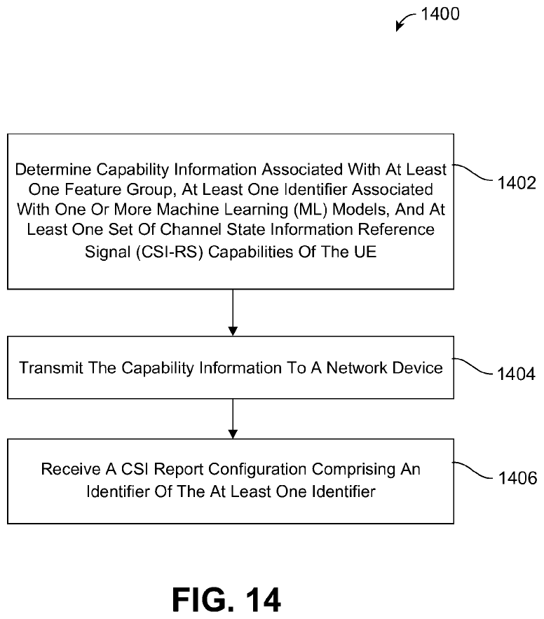

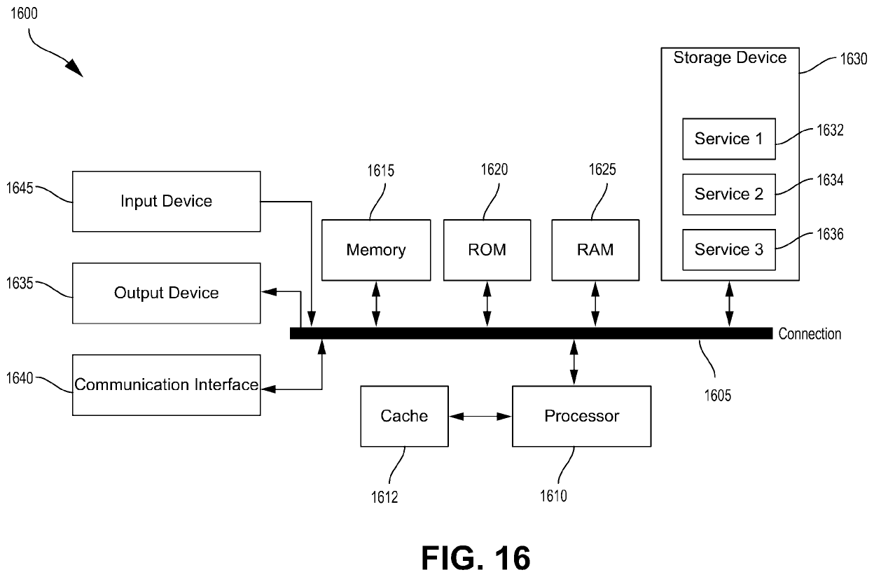

FIG. 14 is a flowchart of an example method 1400 for providing wireless communications at a UE in accordance with various aspects of the disclosure. The process 1400 can be performed by a UE (e.g., the UE 751 of FIG. 7) or a component or system (e.g., a chipset) of the UE or of any device. The operations of the process 1400 may be implemented as software components that are executed and run on one or more processors (e.g., a processor 1610 of FIG. 16 or other processor(s)). Further, the transmission and reception of signals by the UE in the process 1400 may be enabled, for example, by one or more antennas and/or one or more transceivers (e.g., wireless transceiver(s)).

At block 1402, the UE may determine capability information associated with at least one feature group, at least one identifier associated with one or more ML models, and at least one set of CSI-RS capabilities of the UE. The at least one identifier is associated with the one or more ML models and includes at least one pairing identifier associated with an ML-based model (e.g., ML-based encoder) of the UE and an ML-based model (e.g., ML-based decoder) of the network entity. In some aspects, the at least one feature group corresponds to at least one of a rank, a number of subbands, a payload, a number of precoding matrices per subband, or precoding restriction. For example, the feature group can have high complexity, medium complexity, and low complexity based on the number of resources to configure (e.g., rank, number of subbands, etc.). According to some aspects, the at least one set of CSI-RS capabilities includes a maximum number of ports, a maximum number or resources, and a maximum number of ports per resource.

An example of capability information comprises, for each pairing identifier of the at least one pairing identifier, a respective feature group from the at least one feature group and a respective set of CSI-RS capabilities from the at least one set of CSI-RS capabilities corresponding to the respective feature group. Each configuration of capability information identifies a pairing identifier, a feature group, and a CSI-RS capability that is supported by the UE.

Another example of capability information comprises, for each pairing identifier of the at least one pairing identifier, a respective feature group from the at least one feature group and a respective set of CSI-RS capabilities from the at least one set of CSI-RS capabilities corresponding to the respective feature group. Each configuration identifies a respective feature group, CSI-RS capability and pairing identifier that is supported by the UE.

At block 1404, the UE may transmit the capability information to a network entity. For example, the UE may transmit the capability information to a gNB.

At block 1406, the UE may receive a CSI report configuration which comprises an identifier of the at least one identifier (e.g., one of the identifiers from the at least one identifier). For example, the identifier can identify an ML-based encoder for the UE to encode CSI.

In some aspects, the CSI report configuration can include explicit information corresponding to a maximum payload. In one aspect, the CSI report configuration includes payload information associated with a maximum payload for a CSI report generated by an ML model indicated by the identifier. In one non-limiting example, the payload information is based on at least one of a number of subbands or subband ranges, a number of ports or port ranges, or rank or rank group. In another example, the payload information is based on a predetermined number of subbands, and a number of subbands configured for the UE. In yet another example, the payload information is based on a predetermined number of ports, and a number of ports signaled configured to for the UE. In some aspects, a scaling factor can also be used to determine the maximum payload, and the scaling factor can be predetermined as defined by the standard. In some cases, the scaling factor can be determined based on the identifier or is determined based on offline model development.

In some aspects, the CSI report configuration can include at least one parameter associated with the latent message. Parameters associated with the latent message include total dimensions of a CSI feature representation of the CSI report output by one or more ML encoders of the UE (e.g., d_z), a codeword length for quantization of a subset of values of the CSI feature representation (e.g., cw_len), or a number of bits used for quantization of the subset of values of the CSI feature representation (e.g., Q). In some aspects, the parameters can scale with the number of subbands or the range of subbands, the number of ports of the port rage, or the rank or rank-group.

In some aspects, the UE may transmit a CSI feature representation output by an ML-based encoder of the UE. The CSI feature representation may be transmitted in a latent message. In some cases, the CSI feature representation includes information identifying a number of non-zero coefficients and locations of the number of non-zero coefficients. In one example, the UE may identifying a number of non-zero coefficients and locations of the number of non-zero coefficients. In another case, the CSI feature representation includes an index identifying a location of each non-zero coefficient of a plurality of non-zero coefficients in the CSI feature representation. The CSI feature representation includes an index identifying a location of each non-zero coefficient of a plurality of non-zero coefficients in the CSI feature representation. In yet another example, the CSI feature representation includes a number of non-zero coefficients in the CSI feature representation, wherein the non-zero coefficients are located before zero-value coefficients in the CSI feature representation.

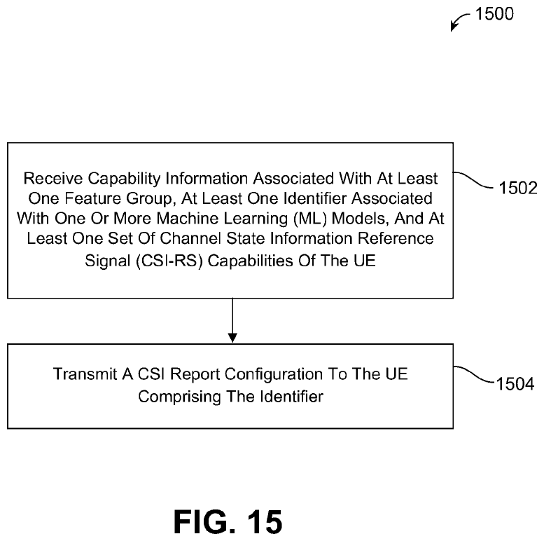

FIG. 15 is a flow diagram illustrating an example of a process or method 1500 for wireless communication. The process 1500 can be performed by a network entity such as a base station (e.g., by the BS 753 of FIG. 7 or gNB) or a portion thereof (e.g., a CU, DU, RU, etc. of the base station). The operations of the process 1500 may be implemented as software components that are executed and run on one or more processors (e.g., processor 1610 of FIG. 16 or other processor(s)). Further, the transmission and reception of signals by the UE in the process 1500 may be enabled, for example, by one or more antennas and/or one or more transceivers (e.g., wireless transceiver(s)).

At block 1502, the network entity may receive capability information associated with at least one feature group, at least one identifier associated with one or more ML models, and at least one set of CSI-RS capabilities of the UE. In one aspect, the capability information includes at least one identifier associated with one or more ML models and at least one set of CSI-RS capabilities of the UE. The at least one identifier is associated with the one or more ML models and includes at least one pairing identifier associated with an ML-based model (e.g., ML-based encoder) of the UE and an ML-based model (e.g., ML-based decoder) of the network entity. In some aspects, the at least one feature group corresponds to at least one of a rank, a number of subbands, a payload, a number of precoding matrices per subband, or precoding restriction. For example, the feature group can have high complexity, medium complexity, and low complexity based on the number of resources to configure (e.g., rank, number of subbands, etc.). According to some aspects, the at least one set of CSI-RS capabilities includes a maximum number of ports, a maximum number or resources, and a maximum number of ports per resource.

An example of capability information comprises, for each pairing identifier of the at least one pairing identifier, a respective feature group from the at least one feature group and a respective set of CSI-RS capabilities from the at least one set of CSI-RS capabilities corresponding to the respective feature group. Each configuration of capability information identifies a pairing identifier, a feature group, and a CSI-RS capability that is supported by the UE.

Another example of capability information comprises, for each pairing identifier of the at least one pairing identifier, a respective feature group from the at least one feature group and a respective set of CSI-RS capabilities from the at least one set of CSI-RS capabilities corresponding to the respective feature group. Each configuration identifies a respective feature group, CSI-RS capability and pairing identifier that is supported by the UE.

In some aspects, the network entity may select an identifier from the form the capability information that identifies an ML-based encoder for the UE and an ML-based decoder for the network entity to decode messages.

At block 1504, the network entity may transmit a CSI report configuration to the UE including an identifier of the at least one identifier (e.g., one of the identifiers from the at least one identifier). The UE may begin to report a latent message encoded by an ML-based encoder corresponding to the identifier, and the network entity decodes the CSI.

In some examples, the processes described herein (e.g., method 1400, method 1500, and/or other process described herein) may be performed by a computing device or apparatus. In one example, the methods 1400 and 1500 can be performed by a computing device (e.g., the computing system 470 in FIG. 4) having a computing architecture of the computing system 1600 shown in FIG. 16.

The processes 1400 and 1500 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the methods.

The processes 1400, 1500, and/or other method or process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 16 is a diagram illustrating an example of a system for implementing certain aspects of the present technology. In particular, FIG. 16 illustrates an example of computing system 1600, which can be for example any computing device making up internal computing system, a remote computing system, a camera, or any component thereof in which the components of the system are in communication with each other using connection 1605. Connection 1605 can be a physical connection using a bus, or a direct connection into processor 1610, such as in a chipset architecture. Connection 1605 can also be a virtual connection, networked connection, or logical connection.

In some aspects, computing system 1600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1600 includes at least one processing unit (CPU or processor) 1610 and connection 1605 that couples various system components including system memory 1615, such as ROM 1620 and RAM 1625 to processor 1610. Computing system 1600 can include a cache 1612 of high-speed memory connected directly with, in close proximity to, or integrated as part of processor 1610.

Processor 1610 can include any general purpose processor and a hardware service or software service, such as services 1632, 1634, and 1636 stored in storage device 1630, configured to control processor 1610 as well as a special-purpose processor where software instructions are incorporated into the actual processor design. Processor 1610 may essentially be a completely self-contained computing system, containing multiple cores or processors, a bus, memory controller, cache, etc. A multi-core processor may be symmetric or asymmetric.

To enable user interaction, computing system 1600 includes an input device 1645, which can represent any number of input mechanisms, such as a microphone for speech, a touch-sensitive screen for gesture or graphical input, keyboard, mouse, motion input, speech, etc. Computing system 1600 can also include output device 1635, which can be one or more of a number of output mechanisms. In some instances, multimodal systems can enable a user to provide multiple types of input/output to communicate with computing system 1600. Computing system 1600 can include communications interface 1640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1640 may also include one or more Global Navigation Satellite System (GNSS) receivers or transceivers that are used to determine a location of the computing system 1600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1630 can include software services, servers, services, etc., that when the code that defines such software is executed by the processor 1610, it causes the system to perform a function. In some aspects, a hardware service that performs a particular function can include the software component stored in a computer-readable medium in connection with the necessary hardware components, such as processor 1610, connection 1605, output device 1635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative Aspects of the present disclosure include:

Aspect 1. A method of wireless communications at a user equipment (UE), the method comprising: determining capability information associated with at least one feature group, at least one identifier associated with one or more machine learning (ML) models, and at least one set of channel state information reference signal (CSI-RS) capabilities of the UE; transmitting the capability information to a network entity; and receiving a CSI report configuration comprising an identifier of the at least one identifier.

Aspect 2. The method of Aspect 1, wherein the at least one identifier associated with the one or more ML models includes at least one pairing identifier associated with an ML-based model of the UE and an ML-based model of the network entity.

Aspect 3. The method of any of Aspects 1 to 2, wherein the at least one feature group corresponds to at least one of a rank, a number of subbands, a payload, a number of precoding matrices per subband, or precoding restrictions.

Aspect 4. The method of any of Aspects 1 to 3, wherein the at least one set of CSI-RS capabilities includes a maximum number of ports, a maximum number or resources, and a maximum number of ports per resource.

Aspect 5. The method of any of Aspects 1 to 4, wherein the capability information comprises, for each pairing identifier of the at least one pairing identifier, a respective feature group from the at least one feature group and a respective set of CSI-RS capabilities from the at least one set of CSI-RS capabilities corresponding to the respective feature group.

Aspect 6. The method of any of Aspects 1 to 5, wherein the capability information comprises, for each feature group of the at least one feature group, a respective pairing identifier of the at least one pairing identifier and a respective set of CSI-RS capabilities from the at least one set of CSI-RS capabilities corresponding to the respective pairing identifier.

Aspect 7. The method of any of Aspects 1 to 6, wherein the CSI report configuration further comprises payload information associated with a maximum payload for a CSI report generated by an ML model indicated by the identifier.

Aspect 8. The method of any of Aspects 1 to 7, wherein the payload information is based on at least one of a number of subbands or subband ranges, a number of ports or port ranges, or rank or rank group.

Aspect 9. The method of any of Aspects 1 to 8, wherein the payload information is based on a predetermined number of subbands, and a number of subbands configured for the UE.

Aspect 10. The method of any of Aspects 1 to 9, wherein the payload information is based on a predetermined number of ports and a number of ports configured for the UE.

Aspect 11. The method of any of Aspects 1 to 10, further comprising: determining payload information associated with a maximum payload for a CSI report generated by an ML model indicated by the identifier based on at least one parameter.

Aspect 12. The method of any of Aspects 1 to 11, wherein the at least one parameter includes at least one of total dimensions of a CSI feature representation of the CSI report output by one or more ML encoders of the UE, a codeword length for quantization of a subset of values of the CSI feature representation, or a number of bits used for quantization of the subset of values of the CSI feature representation.

Aspect 13. The method of any of Aspects 1 to 12, further comprising: transmitting a CSI feature representation output by an ML-based encoder of the UE.

Aspect 14. The method of any of Aspects 1 to 13, wherein the CSI feature representation includes information identifying a number of non-zero coefficients and locations of the number of non-zero coefficients.

Aspect 15. The method of any of Aspects 1 to 14, wherein the CSI feature representation includes an index identifying a location of each non-zero coefficient of a plurality of non-zero coefficients in the CSI feature representation.

Aspect 16. The method of any of Aspects 1 to 15, wherein the CSI feature representation includes a number of non-zero coefficients in the CSI feature representation, wherein the non-zero coefficients are located before zero-value coefficients in the CSI feature representation.

Aspect 17. The method of Aspect 16, wherein the number of non-zero coefficients is reported in a first part of the CSI report, while others related to a latent message are reported in a second part.

Aspect 18. A method of wireless communications at a network entity, the method comprising: receiving capability information associated with at least one feature group, at least one identifier associated with one or more machine learning (ML) models, and at least one set of channel state information reference signal (CSI-RS) capabilities of the UE; and transmitting a CSI report configuration to the UE comprising an identifier of the at least one identifier.

Aspect 19. The method of Aspect 18, wherein the at least one identifier associated with the one or more ML models includes at least one pairing identifier associated with an ML-based model of the UE and an ML-based model of the network entity.

Aspect 20. The method of any of Aspects 18 to 19, wherein the at least one feature group corresponds to at least one of a rank, a number of subbands, a payload, a number of precoding matrices per subband, or precoding restrictions.

Aspect 21. The method of any of Aspects 18 to 20, wherein the at least one set of CSI-RS capabilities includes a maximum number of ports, a maximum number or resources, and a maximum number of ports per resource.

Aspect 22. The method of any of Aspects 18 to 21, wherein the capability information comprises, for each pairing identifier of the at least one pairing identifier, a respective feature group from the at least one feature group and a respective set of CSI-RS capabilities from the at least one set of CSI-RS capabilities corresponding to the respective feature group.

Aspect 23. The method of any of Aspects 18 to 22, wherein the capability information comprises, for each feature group of the at least one feature group, a respective pairing identifier of the at least one pairing identifier and a respective set of CSI-RS capabilities from the at least one set of CSI-RS capabilities corresponding to the respective pairing identifier.

Aspect 24. The method of any of Aspects 18 to 23, wherein the CSI report configuration further comprises payload information associated with a maximum payload for a CSI report generated by an ML model indicated by the identifier.

Aspect 25. The method of any of Aspects 18 to 24, wherein the payload information is based on at least one of a number of subbands or subband ranges, a number of ports or port ranges, or rank or rank group.

Aspect 26. The method of any of Aspects 18 to 25, wherein the payload information is based on a predetermined number of subbands, and a number of subbands configured for the UE.

Aspect 27. The method of any of Aspects 18 to 26, wherein the payload information is based on a predetermined number of ports and a number of ports configured for the UE.

Aspect 28. The method of any of Aspects 18 to 27, wherein the payload information identifies at least one parameter, wherein the UE determines a maximum payload for a CSI report generated by an ML model indicated by the identifier based on the at least one parameter.

Aspect 29. The method of any of Aspects 18 to 28, wherein the at least one parameter includes at least one of total dimensions of a CSI feature representation of the CSI report output by one or more ML encoders of the UE, a codeword length for quantization of a subset of values of the CSI feature representation, or a number of bits used for quantization of the subset of values of the CSI feature representation.

Aspect 30. The method of any of Aspects 18 to 29, further comprising: receiving a CSI feature representation output by an ML-based encoder of the UE.

Aspect 31. The method of any of Aspects 18 to 30, wherein the CSI feature representation includes information identifying a number of non-zero coefficients and locations of the number of non-zero coefficients.

Aspect 32. The method of any of Aspects 18 to 31, wherein the CSI feature representation includes an index identifying a location of each non-zero coefficient of a plurality of non-zero coefficients in the CSI feature representation.

Aspect 33. The method of any of Aspects 18 to 32, wherein the CSI feature representation includes a number of non-zero coefficients in the CSI feature representation, wherein the non-zero coefficients are located before zero-value coefficients in the CSI feature representation.

Aspect 34. The method of Aspect 33, wherein the number of non-zero coefficients is reported in a first part of the CSI report, while others related to a latent message are reported in a second part.

Aspect 35. An apparatus for wireless communication including at least one memory and at least one processor coupled to the at least one memory. The at least one processor is configured to: determine capability information associated with at least one feature group, at least one identifier associated with one or more machine learning (ML) models, and at least one set of channel state information reference signal (CSI-RS) capabilities of the apparatus; transmit the capability information to a network entity; and receive a CSI report configuration comprising an identifier of the at least one identifier.

Aspect 36. The apparatus of Aspect 35, wherein the at least one identifier associated with the one or more ML models includes at least one pairing identifier associated with an ML-based encoder of the apparatus and an ML-based decoder of the network entity.

Aspect 37. The apparatus of any of Aspects 35 to 36, wherein the at least one feature group corresponds to at least one of a rank, a number of subbands, a payload, a number of precoding matrices per subband, or precoding restrictions.

Aspect 38. The apparatus of any of Aspects 35 to 37, wherein the at least one set of CSI-RS capabilities includes a maximum number of ports, a maximum number or resources, and a maximum number of ports per resource.

Aspect 39. The apparatus of any of Aspects 35 to 38, wherein the capability information comprises, for each pairing identifier of the at least one pairing identifier, a respective feature group from the at least one feature group and a respective set of CSI-RS capabilities from the at least one set of CSI-RS capabilities corresponding to the respective feature group.

Aspect 40. The apparatus of any of Aspects 35 to 39, wherein the capability information comprises, for each feature group of the at least one feature group, a respective pairing identifier of the at least one pairing identifier and a respective set of CSI-RS capabilities from the at least one set of CSI-RS capabilities corresponding to the respective pairing identifier.

Aspect 41. The apparatus of any of Aspects 35 to 40, wherein the CSI report configuration further comprises payload information associated with a maximum payload for a CSI report generated by an ML model indicated by the identifier.

Aspect 42. The apparatus of any of Aspects 35 to 41, wherein the payload information is based on at least one of a number of subbands or subband ranges, a number of ports or port ranges, or rank or rank group.

Aspect 43. The apparatus of any of Aspects 35 to 42, wherein the payload information is based on a predetermined number of subbands, and a number of subbands configured for the apparatus.

Aspect 44. The apparatus of any of Aspects 35 to 43, wherein the payload information is based on a predetermined number of ports and a number of ports configured for the apparatus.

Aspect 45. The apparatus of any of Aspects 35 to 44, wherein the at least one processor is configured to: determine payload information associated with a maximum payload for a CSI report generated by an ML model indicated by the identifier based on at least one parameter.

Aspect 46. The apparatus of any of Aspects 35 to 45, wherein the at least one parameter includes at least one of total dimensions of a CSI feature representation of the CSI report output by one or more ML encoders of the apparatus, a codeword length for quantization of a subset of values of the CSI feature representation, or a number of bits used for quantization of the subset of values of the CSI feature representation.

Aspect 47. The apparatus of any of Aspects 35 to 46, wherein the at least one processor is configured to: transmit a CSI feature representation output by the ML-based encoder of the apparatus.

Aspect 48. The apparatus of any of Aspects 35 to 47, wherein the CSI feature representation includes information identifying a number of non-zero coefficients and locations of the number of non-zero coefficients.

Aspect 49. The apparatus of any of Aspects 35 to 48, wherein the CSI feature representation includes an index identifying a location of each non-zero coefficient of a plurality of non-zero coefficients in the CSI feature representation.

Aspect 50. The apparatus of any of Aspects 35 to 49, wherein the CSI feature representation includes a number of non-zero coefficients in the CSI feature representation, wherein the non-zero coefficients are located before zero-value coefficients in the CSI feature representation.

Aspect 51. The apparatus of Aspect 50, wherein the number of non-zero coefficients is reported in a first part of the CSI report, while others related to a latent message are reported in a second part.

Aspect 52. An apparatus for wireless communication including at least one memory and at least one processor coupled to the at least one memory. The at least one processor is configured to: receive capability information associated with at least one feature group, at least one identifier associated with one or more machine learning (ML) models, and at least one set of channel state information reference signal (CSI-RS) capabilities of a UE; and transmit a CSI report configuration to the UE comprising an identifier of the at least one identifier.

Aspect 53. The apparatus of Aspect 52, wherein the at least one identifier associated with the one or more ML models includes at least one pairing identifier associated with an ML-based model of the UE and an ML-based model of the apparatus.

Aspect 54. The apparatus of any of Aspects 52 to 53, wherein the at least one feature group corresponds to at least one of a rank, a number of subbands, a payload, a number of precoding matrices per subband, or precoding restrictions.

Aspect 55. The apparatus of any of Aspects 52 to 54, wherein the at least one set of CSI-RS capabilities includes a maximum number of ports, a maximum number or resources, and a maximum number of ports per resource.

Aspect 56. The apparatus of any of Aspects 52 to 55, wherein the capability information comprises, for each pairing identifier of the at least one pairing identifier, a respective feature group from the at least one feature group and a respective set of CSI-RS capabilities from the at least one set of CSI-RS capabilities corresponding to the respective feature group.

Aspect 57. The apparatus of any of Aspects 52 to 56, wherein the capability information comprises, for each feature group of the at least one feature group, a respective pairing identifier of the at least one pairing identifier and a respective set of CSI-RS capabilities from the at least one set of CSI-RS capabilities corresponding to the respective pairing identifier.

Aspect 58. The apparatus of any of Aspects 52 to 57, wherein the CSI report configuration further comprises payload information associated with a maximum payload for a CSI report generated by an ML model indicated by the identifier.

Aspect 59. The apparatus of any of Aspects 52 to 58, wherein the payload information is based on at least one of a number of subbands or subband ranges, a number of ports or port ranges, or rank or rank group.

Aspect 60. The apparatus of any of Aspects 52 to 59, wherein the payload information is based on a predetermined number of subbands, and a number of subbands configured for the UE.

Aspect 61. The apparatus of any of Aspects 52 to 60, wherein the payload information is based on a predetermined number of ports and a number of ports configured for the UE.

Aspect 62. The apparatus of any of Aspects 52 to 61, wherein the payload information identifies at least one parameter, wherein the UE determines a maximum payload for a CSI report generated by an ML model indicated by the identifier based on the at least one parameter.

Aspect 63. The apparatus of any of Aspects 52 to 62, wherein the at least one parameter includes at least one of total dimensions of a CSI feature representation of the CSI report output by one or more ML encoders of the UE, a codeword length for quantization of a subset of values of the CSI feature representation, or a number of bits used for quantization of the subset of values of the CSI feature representation.

Aspect 64. The apparatus of any of Aspects 52 to 63, wherein the at least one processor is configured to: receive a CSI feature representation output by an ML-based encoder of the UE.

Aspect 65. The apparatus of any of Aspects 52 to 64, wherein the CSI feature representation includes information identifying a number of non-zero coefficients and locations of the number of non-zero coefficients.

Aspect 66. The apparatus of any of Aspects 52 to 65, wherein the CSI feature representation includes an index identifying a location of each non-zero coefficient of a plurality of non-zero coefficients in the CSI feature representation.

Aspect 67. The apparatus of any of Aspects 52 to 66, wherein the CSI feature representation includes a number of non-zero coefficients in the CSI feature representation, wherein the non-zero coefficients are located before zero-value coefficients in the CSI feature representation.

Aspect 68. The apparatus of Aspect 67, wherein the number of non-zero coefficients is reported in a first part of the CSI report, while others related to a latent message are reported in a second part.

Aspect 69. A method of wireless communications at a user equipment (UE), the method comprising: receiving a channel state information (CSI) report configuration comprising an identifier associated with at least one machine learning (ML) model of the UE; and determining, based on the CSI report configuration, a maximum payload for one or more CSI reports generated using the ML model.

Aspect 70. The method of Aspect 69, wherein the CSI report configuration further comprises payload information associated with the maximum payload.

Aspect 71. The method of Aspect 70, wherein the payload information is based on at least one of a number of subbands or subband ranges, a number of ports or port ranges, or rank or rank group.

Aspect 72. The method of any one of Aspects 70 or 71, wherein the payload information is based on a predetermined number of subbands, and a number of subbands configured for the UE.

Aspect 73. The method of any one of Aspects 70 to 72, wherein the payload information is based on a predetermined number of ports and a number of ports configured for the UE.

Aspect 74. The method of Aspect 69, further comprising: determining, based on at least one parameter include in the CSI report configuration, payload information associated with the maximum payload.

Aspect 75. The method of Aspect 74, wherein the at least one parameter includes at least one of a total dimension of a CSI feature representation of the CSI report output by one or more ML encoders of the UE, a codeword length for quantization of a subset of values of the CSI feature representation, or a number of bits used for quantization of the subset of values of the CSI feature representation.

Aspect 76. An apparatus for wireless communications, comprising: at least one memory; and at least one processor coupled to at least one memory and configured to: receive a channel state information (CSI) report configuration comprising an identifier associated with at least one machine learning (ML) model of the apparatus; and determine, based on the CSI report configuration, a maximum payload for one or more CSI reports generated using the ML model.

Aspect 77. The apparatus of Aspect 76, wherein the CSI report configuration further comprises payload information associated with the maximum payload.

Aspect 78. The apparatus of Aspect 77, wherein the payload information is based on at least one of a number of subbands or subband ranges, a number of ports or port ranges, or rank or rank group.

Aspect 79. The apparatus of any one of Aspects 77 or 78, wherein the payload information is based on a predetermined number of subbands, and a number of subbands configured for the apparatus.

Aspect 80. The apparatus of any one of Aspects 77 to 79, wherein the payload information is based on a predetermined number of ports and a number of ports configured for the apparatus.

Aspect 81. The apparatus of any one of Aspects 76 to 80, wherein the at least one processor is configured to: determine, based on at least one parameter include in the CSI report configuration, payload information associated with the maximum payload.

Aspect 82. The apparatus of Aspect 81, wherein the at least one parameter includes at least one of a total dimension of a CSI feature representation of the CSI report output by one or more ML encoders of the apparatus, a codeword length for quantization of a subset of values of the CSI feature representation, or a number of bits used for quantization of the subset of values of the CSI feature representation.

Aspect 83. A non-transitory computer-readable medium having stored thereon instructions that, when executed by at least one processor, cause the at least one processor to perform operations according to any of Aspects 1 to 17.

Aspect 84. An apparatus for processing one or more images, comprising one or more means for performing operations according to any of Aspects 1 to 17.

Aspect 85. A non-transitory computer-readable medium having stored thereon instructions that, when executed by at least one processor, cause the at least one processor to perform operations according to any of Aspects 18 to 34.

Aspect 86. An apparatus for processing one or more images, comprising one or more means for performing operations according to any of Aspects 18 to 34.

Aspect 87. A non-transitory computer-readable medium having stored thereon instructions that, when executed by at least one processor, cause the at least one processor to perform operations according to any of Aspects 69 to 75.

Aspect 88. An apparatus for processing one or more images, comprising one or more means for performing operations according to any of Aspects 69 to 75.

1. An apparatus for wireless communications, comprising:
at least one memory; and
at least one processor coupled to at least one memory and configured to:
determine capability information associated with at least one feature group, at least one identifier associated with one or more machine learning (ML) models, and at least one set of channel state information reference signal (CSI-RS) capabilities of the apparatus;
transmit the capability information to a network entity; and
receive a CSI report configuration comprising an identifier of the at least one identifier.

2. The apparatus of claim 1, wherein the at least one identifier associated with the one or more ML models includes at least one pairing identifier associated with an ML-based model of the apparatus and an ML-based model of the network entity.

3. The apparatus of claim 2, wherein the at least one feature group corresponds to at least one of a rank, a number of subbands, a payload, a number of precoding matrices per subband, or precoding restrictions.

4. The apparatus of claim 2, wherein the at least one set of CSI-RS capabilities includes a maximum number of ports, a maximum number or resources, and a maximum number of ports per resource.

5. The apparatus of claim 2, wherein the capability information comprises, for each pairing identifier of the at least one pairing identifier, a respective feature group from the at least one feature group and a respective set of CSI-RS capabilities from the at least one set of CSI-RS capabilities corresponding to the respective feature group.

6. The apparatus of claim 2, wherein the capability information comprises, for each feature group of the at least one feature group, a respective pairing identifier of the at least one pairing identifier and a respective set of CSI-RS capabilities from the at least one set of CSI-RS capabilities corresponding to the respective pairing identifier.

7. The apparatus of claim 2, wherein the CSI report configuration further comprises payload information associated with a maximum payload for a CSI report generated by an ML model indicated by the identifier.

8. The apparatus of claim 7, wherein the payload information is based on at least one of a number of subbands or subband ranges, a number of ports or port ranges, or rank or rank group.

9. The apparatus of claim 7, wherein the payload information is based on a predetermined number of subbands, and a number of subbands configured for the apparatus.

10. The apparatus of claim 7, wherein the payload information is based on a predetermined number of ports and a number of ports configured for the apparatus.

11. The apparatus of claim 2, wherein the at least one processor is configured to:
determine payload information associated with a maximum payload for a CSI report generated by an ML model indicated by the identifier based on at least one parameter.

12. The apparatus of claim 11, wherein the at least one parameter includes at least one of a total dimension of a CSI feature representation of the CSI report output by one or more ML encoders of the apparatus, a codeword length for quantization of a subset of values of the CSI feature representation, or a number of bits used for quantization of the subset of values of the CSI feature representation.

13. The apparatus of claim 1, wherein a CSI feature representation output by an ML-based encoder of the apparatus includes information identifying a number of non-zero coefficients and locations of the number of non-zero coefficients.

14. The apparatus of claim 1, wherein a CSI feature representation output by an ML-based encoder of the apparatus includes an index identifying a location of each non-zero coefficient of a plurality of non-zero coefficients in the CSI feature representation.

15. The apparatus of claim 1, wherein a CSI feature representation output by an ML-based encoder of the apparatus includes a number of non-zero coefficients in the CSI feature representation, wherein the non-zero coefficients are located before zero-value coefficients in the CSI feature representation.

16. The apparatus of claim 15, wherein the number of non-zero coefficients is reported in a first part of the CSI report, while others related to a latent message are reported in a second part.

17. A method of wireless communications at a user equipment (UE), the method comprising:
determining capability information associated with at least one feature group, at least one identifier associated with one or more machine learning (ML) models, and at least one set of channel state information reference signal (CSI-RS) capabilities of the UE;
transmitting the capability information to a network entity; and
receiving a CSI report configuration comprising an identifier of the at least one identifier.

18. An apparatus for wireless communications, comprising:
at least one memory; and
at least one processor coupled to at least one memory and configured to:
receive capability information associated with at least one feature group, at least one identifier associated with one or more machine learning (ML) models, and at least one set of channel state information reference signal (CSI-RS) capabilities of a user equipment (UE); and
transmit a CSI report configuration to the UE comprising an identifier of the at least one identifier.

19. The apparatus of claim 18, wherein the at least one identifier associated with the one or more ML models includes at least one pairing identifier associated with an ML-based model of the UE and an ML-based model of the apparatus.

20. The apparatus of claim 19, wherein the at least one feature group corresponds to at least one of a rank, a number of subbands, a payload, a number of precoding matrices per subband, or precoding restrictions.

21-35. (canceled)
